(19) United States
(12) Patent Application Publication
(10) Pub. No.: US 2015/0332070 A1
(43) Pub. Date: Nov. 19, 2015

(54) MONITORING USING LOW MODULATION RATE RFID

(71) Applicant: Horse Sense Shoes, LLC, Plymouth, MN (US)

(72) Inventors: Roger Roisen, Minnetrista, MN (US); Michael McHugh, Plymouth, MN (US)

(21) Appl. No.: 14/805,566

(22) Filed: Jul. 22, 2015

Related U.S. Application Data
(63) Continuation of application No. PCT/US2014/011900, filed on Jan. 16, 2014.
(60) Provisional application No. 61/755,207, filed on Jan. 22, 2013.

(51) Int. Cl. G06K 7/10

(52) U.S. Cl. CPC G06K 7/10009

(57) ABSTRACT

A system includes a radio frequency integrated circuit having a low modulation frequency adapted to be compatible with long distance transmission of identification information and circuitry coupled to the radio frequency integrated circuit to initiate periodic transmissions of the identification information. A further system includes a bus, a processor coupled to the bus, a sensor coupled to the bus to provide sensed information to the processor, and an RFID chip coupled to the processor, the RFID chip having a storage device that is programmable by the processor, wherein the RFID chip transmits information stored in the storage device by the processor responsive to an interrogation signal.

### RELATED APPLICATION

This application is a continuation under 35 U.S.C. 111(a) from International Application No. PCT/US2014/011900, filed Jan. 16, 2014 which claims priority to U.S. Provisional Patent Application Ser. No. 61/755,207, filed Jan. 22, 2013, which are incorporated herein by reference.

### BACKGROUND

Prior systems using RFID technology have been attempted for monitoring and reading a passive RFID tag via an RF energy field broadcast from a handheld or forklift mounted reader. The read range limitations of said devices are limited to a few feet or less in the presence of liquid assets or other densely packed materials due to suppression of the RF energy field. Widely used RFID interrogation techniques have failed to address the issue of read range for tightly stacked pallets of liquid assets. Current solutions require inefficient and time consuming movement of pallets to allow for a RFID reader to interrogate the tags.

### SUMMARY

A system includes a radio frequency integrated circuit having a low modulation frequency adapted to be compatible with long distance transmission of identification information and circuitry coupled to the radio frequency integrated circuit to initiate periodic transmissions of the identification information.

A method includes attaching a beacon device proximate an asset, generating a periodic transmit signal via the beaconing device, and transmitting a signal via the beacon device, the signal having a low modulation frequency adapted to be compatible with long distance transmission of identification information.

A further system includes a bus, a processor coupled to the bus, a sensor coupled to the bus to provide sensed information to the processor, and an RFID chip coupled to the processor, the RFID chip having a storage device that is written to by the processor, wherein the RFID chip transmits information stored in the storage device by the processor responding to an interrogation signal typically compliant with the RFID C1G2 specification.

A further system includes an audible or visual indicator for location of asset or notification of an event such as a piezo buzzer and/or LED and/or LCD display.

A further method includes receiving data from a sensor, writing the received data to an RFID storage area, receiving an interrogation signal, and transmitting the data written to the RFID storage area responsive to the interrogation signal. In this case a RFID reader is used to retrieve the data from the tag.

In further embodiments, a monitoring system for use in locating and accounting for assets in a typical warehouse includes a low energy RF beaconing device adapted to penetrate liquids. Beaconing devices may be attached to assets or pallets containing assets such as by sticky backing tape. The beaconing device may also contain a receiver allowing for long distance writing to the Tag. A data collection receiver device acts as a standalone computer capable of receiving data from each beaconing device. The data is transmitted via Ethernet or wireless connection to a cloud data base for user monitoring. In some embodiments the wireless connectivity will be WiFi 802.11, Zigbee 802.15.4 or BTLE 4.0.

### BRIEF DESCRIPTION OF THE DRAWINGS

FIG. 1 is a block schematic view of asset monitoring via a low modulation rate RFID according to an example embodiment.

FIG. 2 is a block schematic view of an RFID patch according to an example embodiment.

FIG. 3 is a block schematic view of a receiver board according to an example embodiment.

FIG. 4 is flowchart representation of a method of transmitting identification signals at a low modulation rate according to an example embodiment.

FIG. 5 is a flowchart representation of a method of transmitting data at a high modulation rate according to an example embodiment.

FIG. 6 is a flowchart representation of a method of receiving and processing identification information according to an example embodiment.

FIG. 7 is block schematic diagram of a computer system for implementing one or more methods and processors according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of firmware and human implemented procedures in one embodiment. The firmware may consist of computer executable instructions stored in flash or FRAM memory. Further, such functions correspond to modules, which are software, hardware, firmware or any combination thereof. Multiple functions may be performed in one or more modules as desired, and the embodiments described are merely examples.

Various embodiments include one or more microcontrollers or digital signal processors in concert with a RF radio operating in the VHF or UHF band of frequencies that execute algorithms to transmit unique identification data at predetermined and or variable intervals in a fashion designed to allow for penetration of liquids.

A monitoring system for use in locating and accounting for assets in a typical warehouse comprises of a low energy RF beaconing device designed to penetrate liquids. The beaconing device may be associated with various assets to be monitored. In one embodiment, the beaconing device may be attached to pallet contents via sticky backing tape. A data collection receiver device acts as a standalone computer capable of receiving data from each pallet that has a beaconing device attached to a pallet. The data is transmitted via Ethernet or wireless connection to a remote server, such as a cloud data base for user monitoring.

In one embodiment, a microcontroller contains an ID related to the contents of the asset. The microcontroller executes the embedded microcode to control a low power RF radio integrated circuit to transmit said data at preprogrammed intervals at a low modulation rate selected to penetrate a densely packed environment, such as pallets of liquor stored for distribution. The low modulation rate allows the transmitted ID to travel longer distances than would otherwise be achieved with common higher modulation rates used to transmit larger amounts of data.

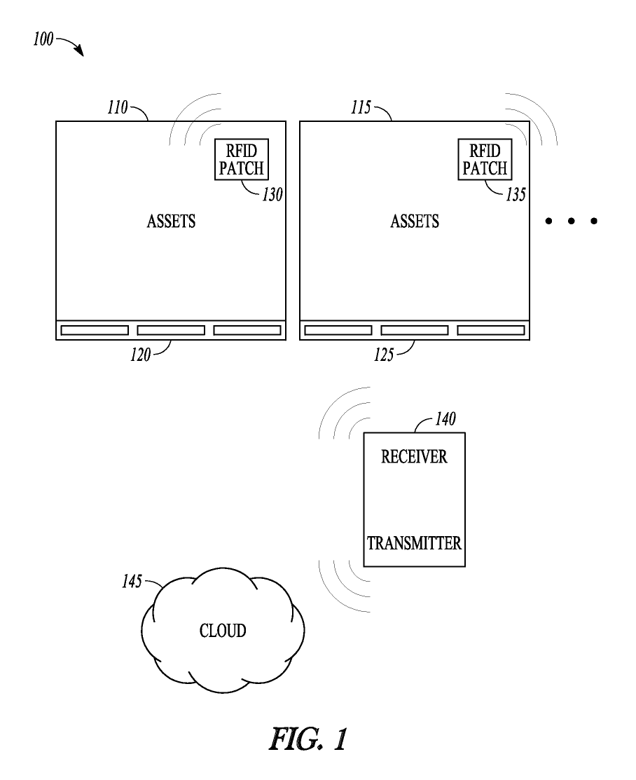

FIG. 1 is a block schematic view of an asset monitoring system 100. Assets 110, 115 to be monitored are stacked on pallets 120, 125 for example. The assets may include liquid, such as liquor bottles in one embodiment. Beaconing devices 130, 135, also referred to as RFID patches, are shown coupled to the assets, but may also be located on the pallets to track either the assets or the pallets. In some embodiment, each asset on a pallet may have a beaconing device if desired. The beaconing devices may be attached with adhesive, tape, or any other type of fastening device. The beaconing devices periodically transmit low modulation rate data, such as, for example, a 64 bit unique ID in one embodiment.

The transmitted data is received by a receiver 140, and may be processed at the receiver to provide a user indication of the presence of the corresponding asset. In one embodiment, the receiver 140 also transmits the data and optionally further information, such as location, time, date, and other information to a remote server, such as cloud 145 based services. The cloud 145 may also contain further information regarding the asset and couple to further information management systems for managing the assets.

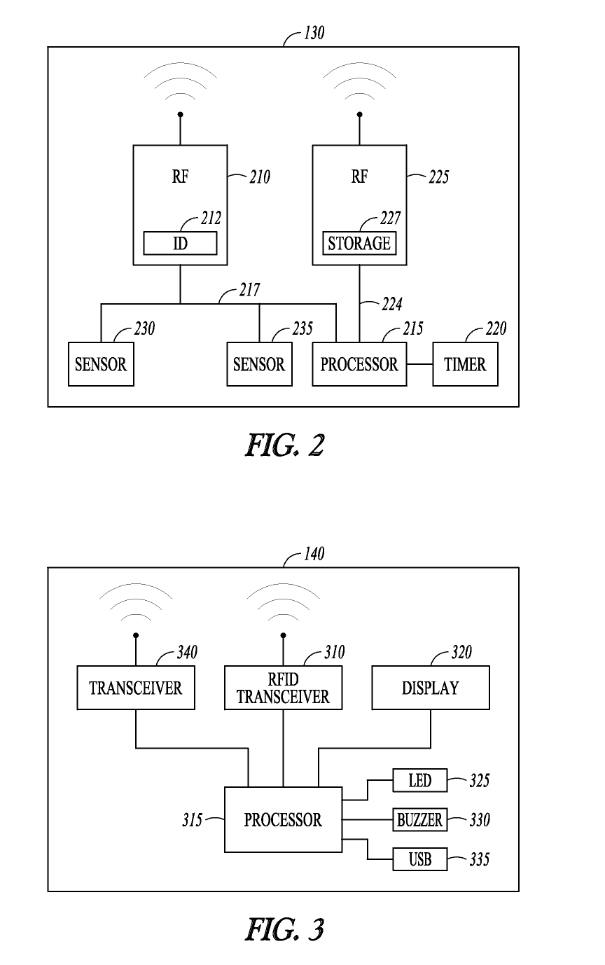

FIG. 2 is a block schematic view of beaconing device 130, also referred to as an RFID patch. Beaconing device 130 includes a RF chip transmitter 210 that may be battery powered. A processor 215 and timer 220 are coupled via a bus 217 to provide a signal to the transmitter 210 to periodically send out an ID from transmitter storage 212. Timer 220 may be a low precision timer in various embodiments, utilizing a small amount of power. Storage 212 may be a buffer, receiving the ID from the processor 215, or may be a non-volatile storage device that received the ID from the processor or was otherwise programmed to provide the ID to be transmitted at a low modulation rate.

In one embodiment, transmitter 210 may be a transmitter implementing IEEE 802.15.4, such as are available from Silicon Labs. The modulation rate is low, in the 0.1 KHz to 1.0 KHz range on a 160 MHz to 434 MHz carrier signal in one embodiment, and provides a longer duration signal for each bit of information to be transmitted, allowing transmission of sufficient signal through densely packed assets, including assets containing mostly liquid. The modulation rate in one embodiment is selected to ensure transmission through such assets at a desired distance and may deviate from the above modulation rate range in order to ensure such transmission in further embodiments.

The amount of information per time period is also selected to be compatible with the corresponding slower transmission rates based on the modulation frequency. In various embodiments, the amount of information may be limited to an ID, such as anywhere from 4 to 40 bytes (8 bits per byte). In one embodiment, the information may comprise a 64 bit ID or other length ID compatible with the modulation frequency. Thus, the amount of information that may be transmitted is restricted by the desired distance to transmit the information. The longer the distance, the smaller the amount of information for a given amount of energy usage.

In various embodiments, modulation at low frequencies allows the limited information to be received at distances exceeding 25 to 100 meters. 100 meters or further is compatible with most large warehouses where pallets of assets are likely to be stored. In an open air type of environment, distances of 1 to 2 kilometers or further may be considered long distances. The term “long distances” may be relative to the type of environment, and in a warehouse containing pallets of liquor or other materials not conducive to electromagnetic radiation transmission, 3, 10, or 100 meters may be a long distance, since typical RFID devices do not function well in such an environment. Thus, a long distance may be thought of as a distance longer then the distance typical RFID devices will work, given the particular environment where they are located. It should be noted that transmitter 210 does not necessarily provide location information, but its transmissions are usually used to ensure that the asset is still present in a general location, such as a warehouse however locations may be determined via relative signal strength, audible/visual alarms or triangulation of packet arrivals.

Beaconing device 130 may also contain an RFID chip 225 with storage 227 that receives interrogation signals and is powered by such interrogation signals to send information from storage 227 in a conventional fashion at a higher modulation rate over distances of around one to ten meters. Example RFID chips includes C1G2 compliant chips such as provided in an integrated circuit form by Cypress, operating at 917 MHz. Other commercially available chips may be used in further embodiments. In one embodiment, RFID chip 225 is coupled to processor 215 via a serial bus 228. In still further embodiments, one or more sensors 230, 235 may be coupled to provide the processor 215 information regarding selected parameters, such as impact, ambient light, temperature, or other factors that may affect the assets. Such information is provided to the processor, and then uploaded to the storage 227 for transmission by the RFID chip and reading by an RFID reader. In one embodiment, the data is serially transmitted via a 2 wire serial bus interface. Example interface configurations are SPIBiWire or I2C or simply “bit banged”. In various example embodiments, the assets may be food requiring refrigeration, and the information may be temperature readings. The processor may also implement algorithms to provide alarms should temperature readings fall outside a threshold or exhibit an undesirable pattern given the asset for which temperature is being measured. Other assets may be sensitive to other environmental factors, and appropriate sensors may be utilized.

FIG. 3 is a block schematic view of a receiver board 140 according to an example embodiment. Receiver board 140 includes a transceiver 310 to receive the signals periodically transmitted by the transmitter 210 containing the small payload such as an ID, indicating that the asset associated with the transmitter is within a receive distance. The transceiver may be an IEEE 802.15.4 transceiver that operates on the same modulation frequency and carrier frequency, and is designed to decode the signal encoded at the low modulation frequency. By transmitting less information, battery life may be conserved. The distance the signal can be received is increased by lowering the signal to noise ratio floor on the receiver side by allowing more time to sample the signal.

The transceiver 310 provides the ID to a processor 315, which may provide a display 320 to a user of the ID, or simply turn on an LED indicator 325, or buzzer 330, to indicate that the asset is within range. Still further, the processor may provide the ID on a port, such as USB port 335 for coupling to another computing device.

In one embodiment, the processor 315 may provide the ID to a further transmitter, such as a Bluetooth transceiver 340 for transmission to an intelligent mobile device, such as a smart phone, PDA, tablet, laptop, or other device capable of receiving such signals. Other types of transmitters, such as 802.15.4 compliant type transmitters, may also be used for such transmissions to couple to still further devices to indicate that the asset is within range of the transceiver 310.

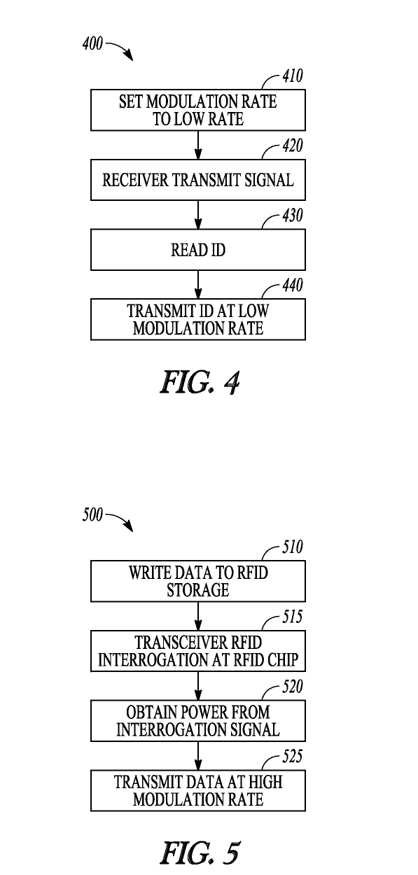

FIG. 4 is flowchart representation of a method 400 of transmitting identification signals at a low modulation rate according to an example embodiment. At 410, the modulation rate is set to a low rate, such 0.5 Khz. As mentioned above, the term “low modulation rate” is intended to be a rate that is suitable for transmitting minimal amounts of data that is receivable and decodable over a distance of up to several hundred meters of densely packed assets, that may include liquids. 0.5 Khz is one example that is suitable for periodically transmitting 64 bit IDs. Note that the modulation rate may be hardwired into the transmitter, or may be adjustable in the field depending on application. Typical ranges are from 0.1 Khz to 10 Khz. Data packet length and read range are inversely proportional. The data packet length is proportional to energy usage.

At 420, a transmit signal is received from the processor and timer indicating that it is time to transmit the ID. The transmitted ID is read at 430, and transmitted at 440 at the low modulation rate. This process repeats with a period programmed into the processor or other circuitry controlling the transmitter.

FIG. 5 is a flowchart representation of a method 500 of transmitting data at a high modulation rate according to an example embodiment. At 510, data is written to storage associated with an RFID integrated circuit chip. The data may be data related to an asset being monitored as described above. At 515, the RFID chip receives an interrogation signal from an external RFID reader and obtains power from the interrogation signal at 520. Utilizing the received power, the RFID chip then transmits data from the associated storage at a high modulation rate, as indicated at 525. The higher modulation rate is 640 Kbps (kilo bits per second means the same as 640 Khz modulation) allows a significantly larger amount of data to be transmitted back to the RFID reader. Such information may include the ID of the asset, as well as information about the asset including sensed parameters and information derived from the sensed parameters, such as might be obtained by applying selected algorithms to the sensed parameters to derive statistics. Process 500 may be repeated each time the RFID chip is interrogated.

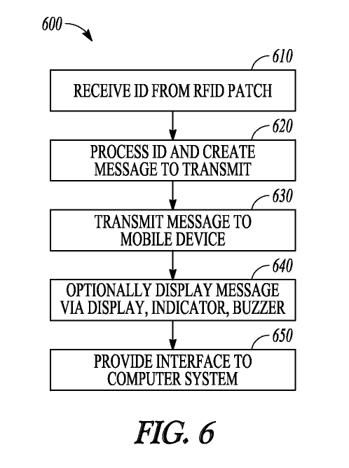

FIG. 6 is a flowchart representation of a method 600 of receiving and processing identification information according to an example embodiment. At 610, and ID is received from a beaconing device. The ID is processed at 620 and a message to transmit further is created. At 630, the message is transmitted to a mobile device, and optionally communicated to a user via a display, LED indicator, piezzo electric buzzer, or other mechanism at 640. In some embodiments, an interface, such as a USB, or other type of connector may be utilized to provide information to a further computer system for further processing and inclusion in business records to aid with management of the assets.

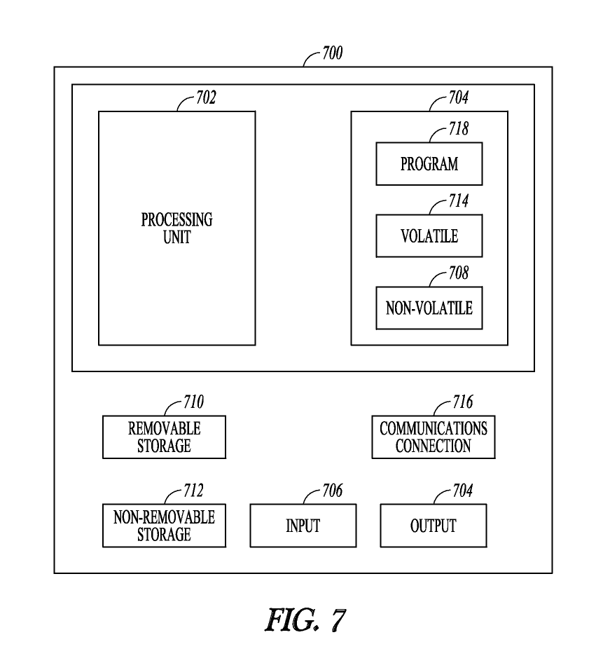

FIG. 7 is a block diagram of a computing device 700, according to an example embodiment. The processors described in some of the above embodiments may include more or fewer components than those shown at 700. Example processors include and 8051 microprocessor or other similar processor. In one embodiment, multiple such computer systems are utilized in a distributed network to implement multiple components in a transaction based environment. An object-oriented, service-oriented, or other architecture may be used to implement such functions and communicate between the multiple systems and components. One example computing device in the form of a computer 700, may include a processing unit 702, memory 704, removable storage 710, and non-removable storage 712. Memory may include volatile memory 714 and non-volatile memory 708. Computer 700 may include—or have access to a computing environment that includes—a variety of computer-readable media, such as volatile memory 714 and non-volatile memory 708, removable storage 710 and non-removable storage 712. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 700 may include or have access to a computing environment that includes input 706, output 704, and a communication connection 716. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN), Ethernet, WiFi, BTLE4.0, 802.15.4, or other networks.

Computer-readable instructions stored on a computer-readable medium are executable by the processing unit 702 of the computer 700. A hard drive, CD-ROM, and RAM are some examples of articles including a non-transitory computer-readable medium. For example, a computer program 718 capable of providing a generic technique to perform access control check for data access and/or for doing an operation on one of the servers in a component object model (COM) based system according to the teachings of the present invention may be included on a CD-ROM and loaded from the CD-ROM to a hard drive. The computer-readable instructions allow computer 700 to provide generic access controls in a COM based computer network system having multiple users and servers.

The following statements are provided as examples, of various embodiments.

1. A system comprising:

a radio frequency integrated circuit having a low modulation frequency adapted to be compatible with long distance transmission of identification information; and

circuitry coupled to the radio frequency integrated circuit to initiate periodic transmissions of the identification information.

2. The system of example 1 wherein the circuitry comprises:

a processor; and

a timer coupled to the processor to provide a time signal from which to determine when to initiate the periodic transmissions.

3. The system of example 2 wherein the modulation frequency is between approximately 0.1 KHz to 1.0 KHz.

4. The system of any of examples 2-3 and further comprising:

a bus to couple the processor to the radio frequency integrated circuit; and

a sensor coupled to the bus to provide sensed information to the processor.

5. The system of example 4 wherein the sensor is selected from a group of sensors consisting of temperature, light, and impact.

6. The system of any of examples 4-5 and further comprising an RFID chip coupled to the processor, wherein the RFID chip comprises a storage device that is writable by the processor.

7. The system of example 6 wherein the RFID chip is adapted to transmit information from the storage device responsive to an externally originated interrogation signal.

8. The system of example 7 wherein the RFID chip derives power from the external interrogation signal.

9. The system of any of examples 7-8 wherein the transmitted information includes the identification information and sensed information.

10. A method comprising:

attaching a beacon device proximate an asset;

generating a periodic transmit signal via the beaconing device; and

transmitting a signal via the beacon device, the signal having a low modulation frequency adapted to be compatible with long distance transmission of identification information.

11. The method of example 10 wherein the transmit signal is generated by a processor and timer.

12. The method of any of examples 10-11 wherein the modulation frequency is between approximately 0.1 KHz to 1.0 KHz.

13. The method of any of examples 10-12 and further comprising:

sensing a parameter; and

providing sensed information representative of the sensed parameter to the processor.

14. The method of example 13 and further comprising:

writing the sensed information to a storage device on an RFID chip; and

transmitting information from the storage device via the RFID chip responsive to an externally originated interrogation signal.

15. A system comprising:

a bus;

a processor coupled to the bus;

a sensor coupled to the bus to provide sensed information to the processor; and

an RFID chip coupled to the processor, the RFID chip having a storage device that is programmable by the processor, wherein the RFID chip transmits information stored in the storage device by the processor responsive to an interrogation signal.

16. The system of example 15 wherein the sensor is selected from a group of sensors consisting of temperature, light, and impact.

17. The system of any of examples 15-16 wherein the RFID chip derives power from the external interrogation signal.

18. The system of any of examples 15-17 wherein the transmitted information includes the identification information and sensed information.

19. A method comprising:

receiving data from a sensor;

writing the received data to an RFID storage area;

receiving an interrogation signal; and

transmitting the data written to the RFID storage area responsive to the interrogation signal.

20. The method of example 19 wherein the data from the sensor is representative of at least one of sensed temperature, light, and impact.

21. The method of any of examples 19-20 wherein the RFID chip derives power from the interrogation signal.

The following statements are potential claims that may be converted to claims in a future application. No modification of the following statements should be allowed to affect the interpretation of claims which may be drafted when this provisional application is converted into a regular utility application.

What is claimed is:

1. A system comprising:
a radio frequency integrated circuit having a low modulation frequency between approximately 0.1 KHz to 1.0 KHz adapted to be compatible with long distance transmission of identification information; and
circuitry coupled to the radio frequency integrated circuit to initiate periodic transmissions of the identification information, wherein the circuitry comprises:
a processor; and
a timer coupled to the processor to provide a time signal from which to determine when to initiate the periodic transmissions.

2. The system of claim 1 and further comprising:
a bus to couple the processor to the radio frequency integrated circuit; and
a sensor coupled to the bus to provide sensed information to the processor.

3. The system of claim 2 wherein the sensor is selected from a group of sensors consisting of temperature, light, and impact.

4. The system of claim 2 and further comprising an RFID chip coupled to the processor, wherein the RFID chip comprises a storage device that is writable by the processor.

5. The system of claim 4 wherein the RFID chip is adapted to transmit information from the storage device responsive to an externally originated interrogation signal.

6. The system of claim 5 wherein the RFID chip derives power from the external interrogation signal.

7. The system of claim 5 wherein the transmitted information includes the identification information and sensed information.

8. A method comprising:
attaching a beacon device proximate an asset;
generating a periodic transmit signal via the beaconing device; and
transmitting a signal via the beacon device, the signal having a low modulation frequency between approximately 0.1 KHz to 1.0 KHz adapted to be compatible with long distance transmission of identification information.

9. The method of claim 8 wherein the transmit signal is generated by a processor and timer.

10. The method of claim 9 and further comprising:
sensing a parameter; and
providing sensed information representative of the sensed parameter to the processor.

11. The method of claim 10 and further comprising:
writing the sensed information to a storage device on an RFID chip; and
transmitting information from the storage device via the RFID chip responsive to an externally originated interrogation signal.
